(19) United States
(12) Patent Application Publication
(10) Pub. No.: US 2026/0204977 A1
(43) Pub. Date: Jul. 16, 2026

(54) MOTOR DRIVE DEVICE

(71) Applicant: DENSO CORPORATION, Kariya-city (JP)

(72) Inventor: Atsushi KATO, Kariya-city (JP)

(21) Appl. No.: 19/562,088

(22) Filed: Mar. 10, 2026

Related U.S. Application Data
(63) Continuation of application No. PCT/JP2024/031902, filed on Sep. 5, 2024.

(30) Foreign Application Priority Data
Sep. 13, 2023 (JP) 2023-148224

(51) Int. Cl. H02K 5/18; H02K 11/33

(52) U.S. Cl. CPC H02K 5/18; H02K 11/33; H02K 2211/03

(57) ABSTRACT

A motor drive device has a motor unit, a circuit unit, and a housing. The motor unit has a stator around which a motor winding is wound, a rotor that rotates by energizing the motor winding, and a shaft that rotates together with the rotor. The circuit unit has a circuit board on which electronic components relating to energizing control of the motor winding are mounted. The housing has a motor housing portion that accommodates the motor unit, a circuit housing portion that accommodates the circuit unit, and heat dissipating fins formed on an outer surface. The motor housing portion, the circuit housing portion, and the heat radiation fins are integrally molded.

### CROSS REFERENCE TO RELATED APPLICATIONS

The present application is a continuation application of International Patent Application No. PCT/JP2024/031902 filed on September 5, 2024, which designated the U.S. and is based on Japanese Patent Application No. 2023-148224, filed on September 13, 2023, the entire disclosure of this application is incorporated herein by reference.

### TECHNICAL FIELD

The present disclosure relates to a motor drive device.

### BACKGROUND

A motor drive device includes both a motor unit and a circuit unit. The circuit unit is configured to control the motor unit. Firm and secure connection between the motor unit and the circuit unit is required. In the above aspects, or in other aspects not mentioned, there is a need for further improvements in a motor drive device.

### SUMMARY

The motor drive device of this disclosure has a motor unit, a circuit unit, and a housing. The motor unit has a stator on which a motor winding is wound, a rotor that is rotated by energizing the motor winding, and a shaft that rotates together with the rotor. The circuit unit has a circuit board on which electronic components related to energizing control for the motor winding are mounted.

The housing has a motor housing portion that houses the motor unit and a circuit housing portion that houses the circuit unit, and is formed with heat dissipation fins on an outer surface thereof. The motor housing portion, the circuit housing portion, and the heat radiation fins are integrally molded. This avoids loosening of connections in the motor housing portion and the circuit housing portion, even when the external forces such as wind pressure applied to the heat radiation fins are applied.

The above and other objectives, features and advantages of the present disclosure will become more apparent from the following detailed description with reference to the accompanying drawings.

### BRIEF DESCRIPTION OF DRAWINGS

FIG. 1 is a schematic diagram of an electric motorcycle according to a first embodiment.

FIG. 2 is a perspective view of a motor drive device according to the first embodiment.

FIG. 3 is a plan view of the motor driven device according to the first embodiment.

FIG. 4 is a diagram in a direction shown by an arrow symbol IV in FIG. 3.

FIG. 5 is a diagram in a direction shown by an arrow symbol V in FIG. 3.

FIG. 6 is a cross-sectional view on a line VI-VI in FIG. 3.

FIG. 7 is a plan view of the motor drive device according to a second embodiment.

### DETAILED DESCRIPTION

JP2015-146710A discloses a motor drive unit configured as an integrated mechanical and electrical unit. This unit uses fastening devices, such as screws, to fix the motor case and the electrical circuit case. The fastening devices may be loosened under vibration environment. It is an object of the present disclosure to provide a motor drive device that can avoid loose connection between a motor unit and a circuit unit due to external forces.

(First Embodiment) A motor drive device according to the present disclosure is described below with reference to the drawings. In the following plural embodiments, substantially same structural configurations are designated with the same reference numerals thereby to simplify the description.

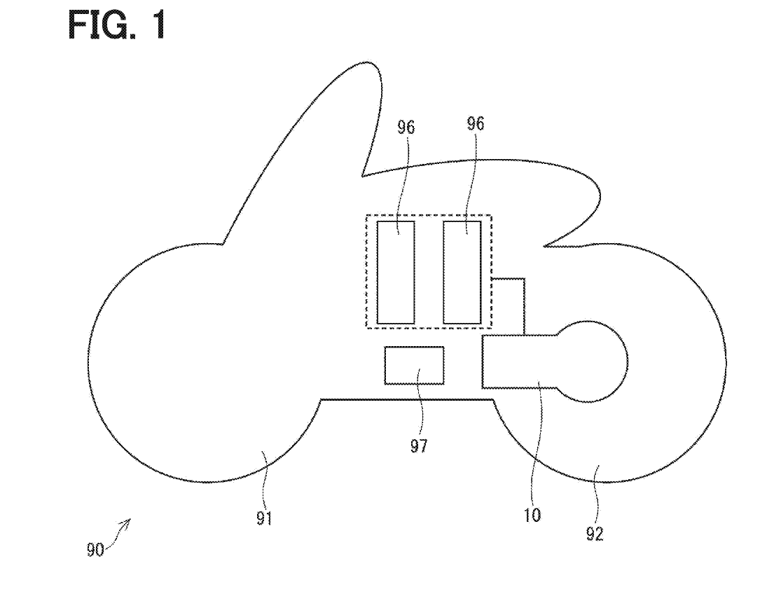

The motor drive device according to a first embodiment is shown in FIGS. 1 to 6. As shown in FIG. 1, the motor drive device 10 is applied, e.g., to an electric motorcycle 90. The electric motorcycle 90 has at least one battery, e.g., a 48 [V] main battery 96, a 12 [V] auxiliary battery 97 and a motor drive device 10. The motor drive device 10 is connected to the main battery 96 as a battery and is driven by power from the main battery 96. In FIG. 1, the motor drive device 10 is installed on a side to a rear wheel 92 of the electric motorcycle 90, but the motor drive device 10 may be installed on a side to a front wheel 91, or on both the front wheel 91 and the rear 92 wheel.

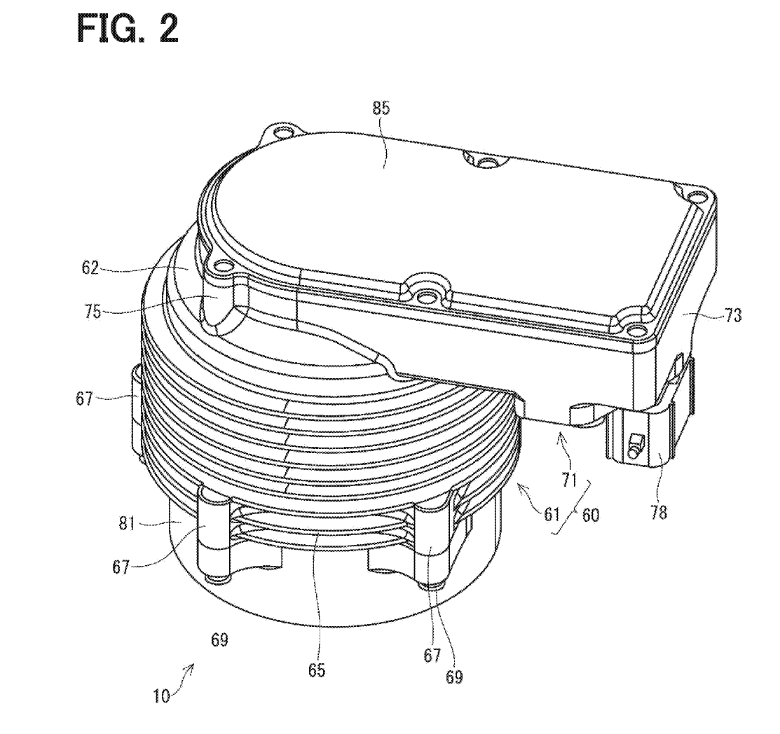

As shown in FIGS. 2 through 6, the motor drive device 10 has a motor unit 20, a circuit unit 40, and a housing 60. The motor drive device 10 is a so-called an integrated mechanical and electrical type in which the circuit unit 40 is mounted on one side of the motor unit 20 in an axial direction.

The motor unit 20 is an electric motor, e.g., three-phase brushless motor, generates drive power transmitted to the rear wheel 92 via gears and other components not shown. The electric motorcycle 90 runs by the drive power of the motor unit 20, and the motor unit 20 may be called a running motor (so-called a main motor).

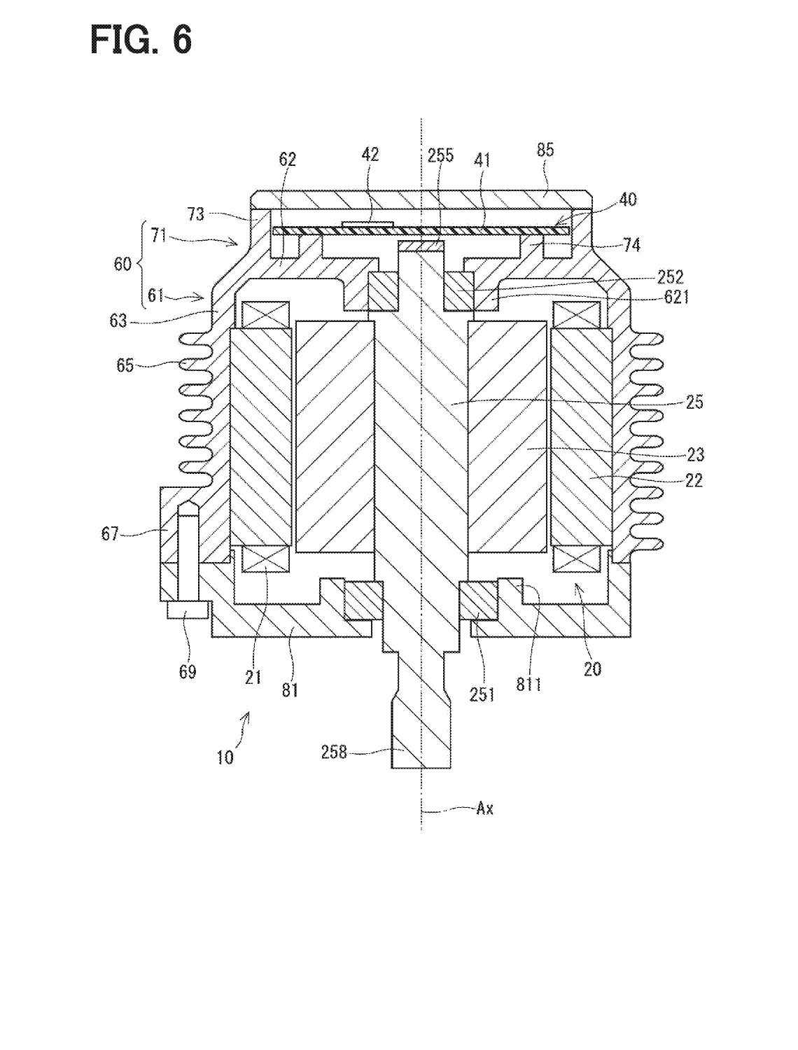

As shown in FIG. 6, the motor unit 20 has a stator 22 around which a motor winding 21 is wound, a rotor 23, and a shaft 25. The stator 22 is fixed to the housing 60. The rotor 23 is provided in a radial direction inside of the stator 22 and is provided relatively rotatable to the stator 22.

The shaft 25 is fitted firmly in the rotor 23 to rotate integrally with the rotor 23. The shaft 25 is supported by bearings 251 and 252 in a rotatable manner. One end of the shaft 25 is exposed from the housing 60 to the circuit unit 40 and is provided with a magnet 255. The other end of the shaft 25 is an output end 258 and is exposed from the housing 60 on an opposite side of the circuit unit 40. The output end 258 is connected to the rear wheel 92 via a reduction gearbox or similar device not shown. As a result, the driving power of the motor unit 20 drives the rear wheel 92. Hereafter, a virtual line extending a shaft center of the shaft 25 is referred to as a rotation axis center Ax. An axial direction of the motor unit 20 is referred to as a motor axial direction or simply an axial direction as appropriate.

The circuit unit 40 has a circuit board 41. The circuit board 41 is shaped according to a shape of a circuit housing portion 71 described below, is placed on the board fixing portion 74, and is fixed to the circuit housing portion 71 with screws or other fixing members not shown. The circuit board 41 is mounted with various electronic components 42 related to a drive control of the motor unit 20, such as rotation angle sensors and switching elements for switching current supply to the motor winding 21. In FIG. 6, one element is described as an example of the electronic components 42. The rotation angle sensor is mounted at a point where the rotating magnetic field of the magnet 255 is detected. Thereby, it is possible to detect rotation of the motor unit 20.

As shown in FIGS. 2 through 6, the housing 60 has a motor housing portion 61 that houses the motor unit 20 and a circuit housing portion 71 that houses the circuit unit 40. The circuit housing portion 71 is formed on one side end of the motor housing portion 61 to protrude in the axial direction, and extends outside in a radial direction. The circuit housing portion 71 generally has a combined shape of a cylinder on the motor axis Ax and a rectangular prism. The rectangular prism provides a portion extending outwardly in the radial direction from the cylinder. The circuit housing portion 71 extends larger than the motor housing portion 61 at the rectangular prism. The circuit housing portion 71 protrudes outwardly more than the motor housing portion 61 to provide a predetermined amount that is sufficient to provide the connector 78 extending parallel to the motor housing portion 61. The connector 78 has an opening to receive another connector. The opening faces the other side end of the motor housing portion 61 that is an opposite end where the circuit housing portion 71 is disposed. In the circuit housing portion 71, a portion connected to the motor housing portion 61 may be referred to as a connecting portion 711 and a portion extending from the motor housing portion 61 may be referred to as an extended portion 712. The motor housing portion 61 and the circuit housing portion 71 are integrally molded from a metallic material such as aluminum, for example. The housing 60 is integrally molded, for example, by sand casting and cutting, or by aluminum die casting.

The frame member 81 is attached by screws or other fixing members 69 on a side opposite to the circuit unit 40 of the housing 60. The frame member 81 has a bearing holding portion 811, in which the bearing 251 is held. A cover 85 made of metal or resin, for example, is attached to a side to the circuit unit 40 of the housing 60 by means of screws or other fixing members not shown. This prevents entering of foreign matters such as water droplets, dust, and other into an inside of the housing 60.

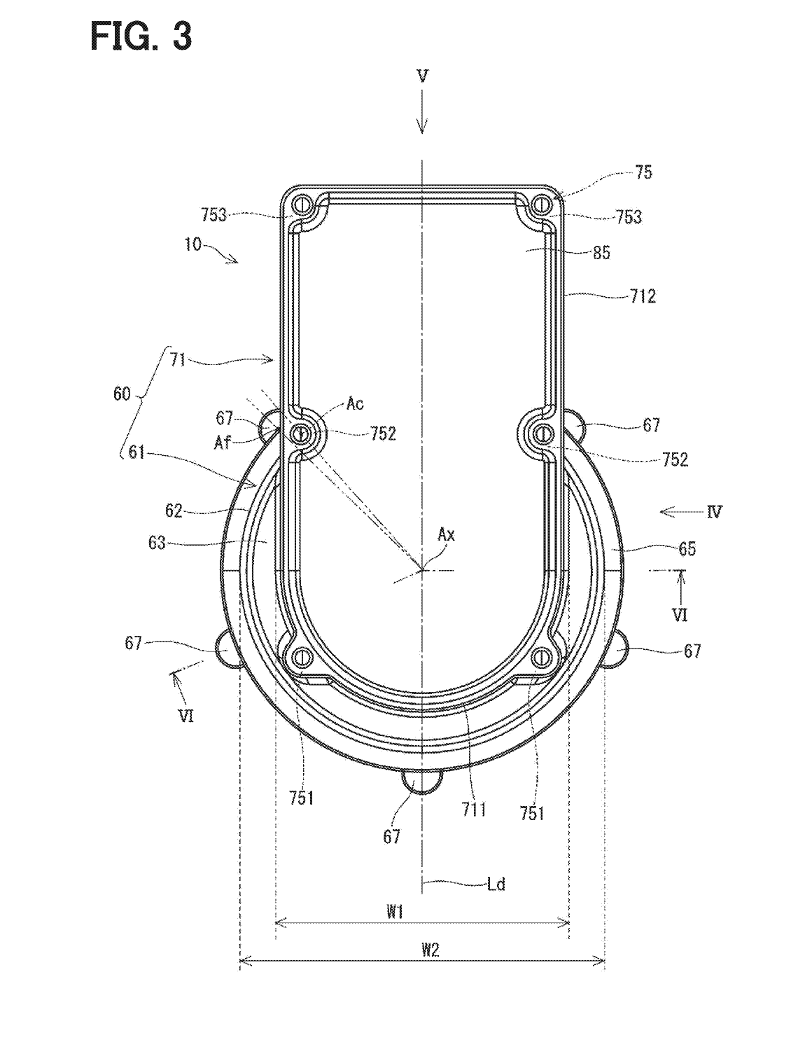

Hereafter, as appropriate, an area within a projected area of the cylinder 63 of the motor housing portion 61 in the axial direction may be referred to as a motor area, and an area within a projected area of the extended portion 712 in the axial direction may be referred to as an extended area. Assuming that an upper side of the paper of FIG. 6 may be referred to as a side to the cover, a direction in which the extended potion 712 extends may be referred to as a extended direction (i.e., an up and down direction on the paper of FIG. 3), and a direction perpendicular to the extended direction may be referred to as a width direction (i.e., a right and left direction on the paper of FIG. 3).

The motor housing portion 61 has a bottom portion 62, a cylinder portion 63, heat radiation fins 65, and a frame attachment portion 67, etc., and is formed as generally a bottomed cylindrical shape having an opening on a side to an output end. The bottom portion 62 is located on a side to the circuit unit 40 and has a bearing holding portion 621 in the center. The bearing holding portion 621 is provided with a bearing 252.

The stator 22 is fixed to an inner side of the cylinder 63 in the radial direction. Heat dissipating fins 65 are formed on a radial outside of the cylinder 63. The heat dissipating fins 65 are circularly formed, projecting radially outward from the cylinder 63. The heat dissipating fins 65 are formed in a plurality of stages in the axial direction. The number and shape of the heat dissipating fins 65 may be set arbitrarily according to a shaft length of the motor unit 20.

On a side to the output end of the cylinder 63, there are a plurality of frame attachment portions 67 protruding radially outward from the cylinder 63. In this embodiment, five frame attachment portions 67 are formed at generally equal intervals. Each one of the multi-staged heat dissipating fins 65 on a side to the output end has a notch 651. The frame attachment portion 67 is located in a notch 651. In other words, the frame attachment portion 67 is provided adjacent to the heat dissipating fin 65 in the circumferential direction. It is possible to downsize an axial size by disposing the heat dissipating fin 65 and the frame attachment portion 67 in an overlapping manner in the axial direction.

As shown in FIG. 3, one of five frame attachment portions 67 is on an imaginary line Ld that passes through the rotation axis center Ax and divides the housing 60 in two along a longitudinal direction, on a side to the connecting portion 711. The remaining four frame attachment portions 67 are symmetrical across the imaginary line Ld, and two of them are located at the boundary between the motor area and the extended area.

As shown in FIGS. 2 through 6, the circuit housing portion 71 has an extended floor portion 72 and a vertical wall 73, etc., and when viewed from a side of the cover, the overall shape is a combination of a semicircle and a rectangle. The semicircular portion is located within the motor area. The rectangular portion is formed by extending outwardly from the semicircular portion to an outside of the motor area. It is possible to increase a mounting area of the circuit board 41 compared to a case where the circuit housing portion 71 is formed within an area of the motor by extending the circuit housing portion 71 and the circuit board 41 to an outside of the motor area.

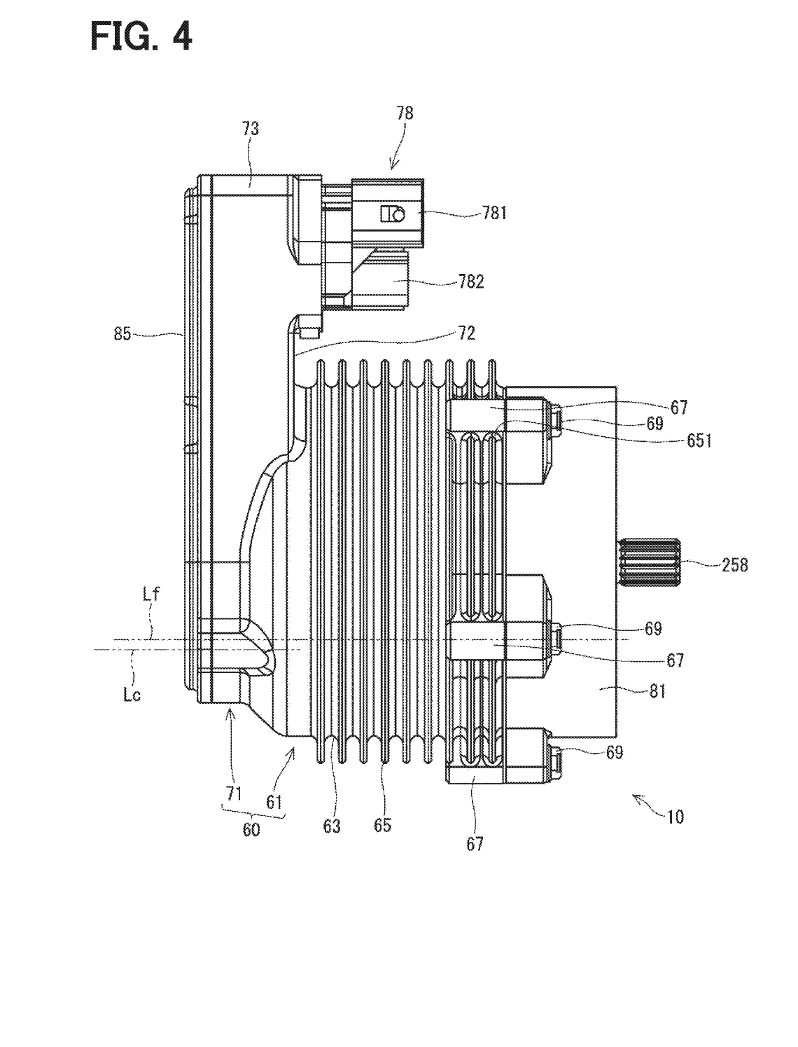

The extended floor portion 72 (see FIG. 4) is formed perpendicular to the rotation axis center Ax and extends radially outward from the motor housing portion 61. The extended floor portion 72 is provided on a side to the output shaft rather than an end surface of the bottom portion 62 to a side of the cover, is connected to the cylinder portion 63 at a point where it does not interfere with the heat dissipation fins 65. The vertical wall 73 is disposed along an outer edge of the circuit housing portion 71 in a rectangular shape and extends parallel to the axial direction.

The circuit board 41 and the electronic components 42 mounted on the circuit board 41 are accommodated in a housing cavity enclosed by a surface of the bottom portion 62 on a side to the cover, an extended floor portion 72, and the vertical wall 73 of the motor housing portion 61. In the motor area, a side of the bottom portion 62 to the output end is the motor housing portion 61 and a side of the bottom portion 62 to the cover is the circuit housing portion 71. The bottom portion 62 may be considered as a partition wall partitioning the motor housing portion 61 and the circuit housing portion 71.

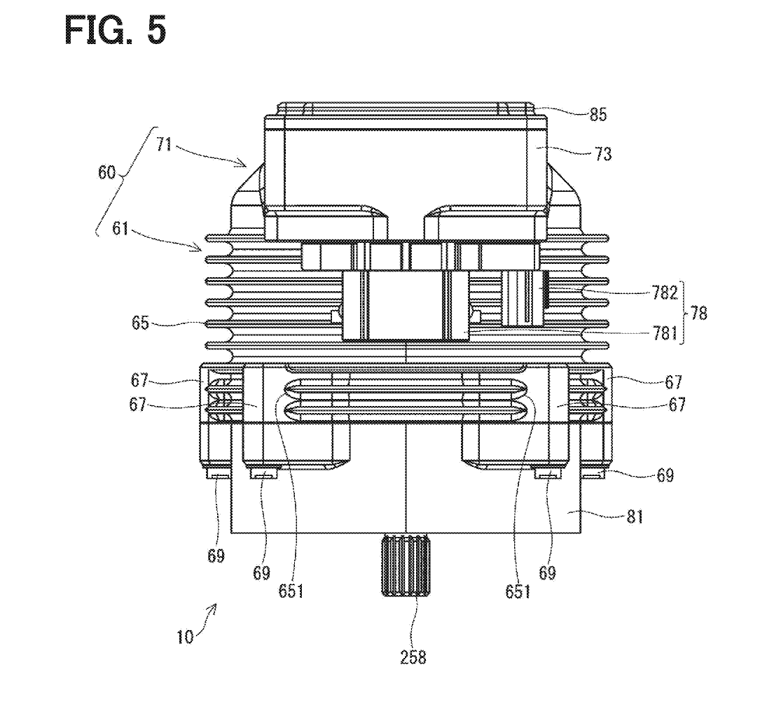

The connector 78 is located on the extended area and is disposed on a side to the distal end of the extended floor 72. An opening of the connector 78 is provided to face a side to the output end (i.e., a lower side on the paper of FIG. 5), and is provided to allow an insertion and removal operation of a wire harness, which is not shown. In other words, the insertion and removal direction of the connector 78 in this embodiment is parallel to the rotation axis center Ax. An orientation of the opening and the direction of insertion and removal may be different. This allows effective use of a dead space created by extending the circuit housing portion 71 in the radial direction.

The connector 78 has a power supply connector 781 and a signal connector 782. The power supply connector 781 is connected to the main battery 96 via a wire harness or other means. The signal connector 782 is connected to external sensors and communication circuits via wire harnesses or other means, and is used to send and receive various signals. In this embodiment, the main battery 96 corresponds to the battery.

The circuit housing portion 71 is provided with a plurality of cover attachment portions 75 to which the cover 85 is attached. The cover attachment portions 75 are provided in six locations, three on each side, roughly parallel to each side across the imaginary line Ld. The cover attachment portions 75 are disposed on both sides of the imaginary line Ld, respectively, at an outside of the semicircular portion of the connecting portion 711, at an end portion of the extended portion 712, and at a boundary between the connecting portion 711 and the extended portion 712. The cover attachment portions 75 are on an underside of the cover 85, but for illustration purposes, the portions corresponding to the cover attachment portions 75 are illustrated with dashed lines in FIG. 3. In FIG. 3, the cover attachment portions 75 are numbered 751, 752, and 753 from a side to the semicircular portion of the connecting portion 711, for illustration purposes.

The cover attachment portion 751 is located on an outside of the vertical wall 73, while the cover attachment portions 752 and 753 are located on an inside of the vertical wall 73. A length W1 in a width direction of the circuit housing portion 71, including the cover attachment portions 75, is smaller than a length W2 in a width direction of the motor housing portion 61 (i.e., a diameter of the cylinder 63 of the motor housing portion 61).

An arrangement of the frame attachment portions 67 and the cover attachment portions 75 is described below. As shown in FIG. 4, although an axis Lf and an axis Lc are arranged close, the axis Lf of the frame attachment portion 67 and the axis Lc of the cover attachment portion 75 are shifted so that they do not overlap. Further, as shown in FIG. 3, projected positions of the frame attachment portion 67 and the cover attachment portion 752 in the axial direction are located relatively close together at a region of the boundary between the motor area and the extended area. Here, on an imaginary plane perpendicular to the rotation axis center Ax, the axis center Af of the frame attachment portion 67 is arranged in a shifted manner so that it does not lie on a straight line connecting the rotation axis center Ax of the motor area 20 and the axis center Ac of the cover attachment portion 75. In other words, the axis center Af of the frame attachment portion 67 and the axis center Ac of the cover attachment portion 75 are not located on the same straight line from the rotation axis center Ax on a plan view parallel to the circuit housing portion 71 and the cover 85.

The motor drive device 10 in this embodiment is connected to the main battery 96, and when a relatively high voltage is applied, the motor drive device 10 becomes hot due to heat generated in the circuit unit 40, etc., so thermal countermeasures are necessary. The relatively high voltage could be applied when two pieces of the main battery 96, i.e., two of 48[V] batteries, are connected in series. In this embodiment, heat dissipating fins 65 are provided in the motor housing portion 61 as a thermal countermeasure.

In this embodiment, the motor drive device 10 is applied to the electric motorcycle, and the device may be vibrated due to external forces such as wind pressure and vehicle vibration applied to the heat radiation fins 65. Therefore, in this embodiment, the motor housing portion 61 and the circuit housing portion 71 are integrally molded from metal. This prevents loosening or damage to the connection points between a side to the motor unit 20 and a side to the circuit unit 40 due to vibration. The motor housing portion 61, the circuit housing portion 71 and the heat radiation fins 65 are molded with a single continuous material.

The motor drive device 10 has an unbalanced shape in which an extended portion 712 of the circuit housing portion 71 protrudes to one side of the outer diameter of the motor housing portion 61 in a radial direction from an outer diameter of the motor housing portion 61. Therefore, if the motor unit 20 becomes vibration source, resonance may occur on a side to the circuit unit 40. Therefore, in this embodiment, the axis of the frame attachment portion 67 and the axis of the cover attachment portion 75 are shifted, and the frame attachment portion 67 and the cover attachment portion 75 are arranged so that they do not line up on the same straight line with respect to the rotation axis center Ax. This prevents resonance, thus it is possible to prevent damage to the frame attachment portions 67 and the cover attachment portions 75, which are formed protruding, and the board fixing portions 74 formed inside the circuit housing portion 71.

As explained above, the motor drive device 10 has the motor unit 20, the circuit unit 40, and the housing 60. The motor unit 20 has a stator 22 on which a motor winding 21 is wound, a rotor 23 that is rotated by energizing the motor winding 21, and a shaft 25 that rotates together with the rotor 23. The circuit unit 40 has a circuit board 41 on which electronic components 42 related to energizing control for the motor winding 21 are mounted.

The housing 60 has a motor housing portion 61 that accommodates the motor unit 20 and a circuit housing portion 71 that accommodates the circuit unit 40, and is formed with heat dissipation fins 65 on an outer surface thereof. In this embodiment, the heat dissipating fins 65 are formed on the outer side of the cylinder 63 of the motor housing portion 61 in the radial direction. The motor housing portion 61, the circuit housing portion 71, and the heat radiation fins 65 are integrally molded.

The device can dissipate heat generated by the motor drive device 10 appropriately by providing the heat dissipating fins 65. In addition, by making the motor housing portion 61, the circuit housing portion 71, and the heat radiation fins 65 as a single piece molded product, an entire body of the housing 60 is stable and vibration and damage can be suppressed even when a load is applied between the motor housing portion 61 and the circuit housing portion 71 due to wind pressure applied to the heat radiation fins. Since the housing 60 is integrally molded, a connection thereof is not loosened by vibration or load, compared to a case where the motor housing portion 61 and the circuit housing portion 71 are formed separately and secured by screws or other means.

The circuit housing portion 71 is provided on a side of one end in the axial direction of the motor housing portion 61, that is formed in a cylindrical shape. The circuit housing portion 71 has a connecting portion 711 connected to the motor housing portion 61 and an extended portion 712 extending outwardly from the connecting portion 711 in the radial direction of the motor housing portion 61. By providing the extended portion 712, it is possible to use the circuit board 41 with a large mounting area. In addition, since the circuit housing portion 71 is apparently exposed to an outside, a heat dissipation efficiency of the circuit portion 40 can be improved.

Assuming that a direction in which the extended portion 712 extends is an extended direction and a direction perpendicular to the extended direction is a width direction, the length W1 in the width direction of the circuit housing portion 71 is smaller than the length W2 in the width direction of the motor housing portion 61. In other words, the connecting portion 711 is connected to a surface on an axial end of the motor housing portion 61 and is contained within the motor area. This stabilizes the connection between the motor housing portion 61 and the circuit housing portion 71, thereby suppressing vibration and damage when a load is applied around the boundary area between the connecting portion 711 and the extended portion 712.

The motor drive device 10 may be connected to the main battery 96 and has the connector 78 on the extended portion 712. The connector 78 is located within a projected area of the extended portion 712 in a direction of the motor axis. In other words, the connector 78 does not protrude from a periphery of the circuit housing portion 71. As a result, it is possible to effectively use a dead space created by providing the extended portion 712.

The motor drive device 10 has the frame member 81 and the cover 85. The frame member 81 is attached to the frame attachment portion 67 provided on the motor housing portion 61 and is provided at an end of the housing 60 on a side to the motor housing portion 61. The cover 85 is attached to the cover attachment portions 75 on the circuit housing portion 71 and is located at an end on a side to the circuit housing portion 71of the housing 60.

The frame attachment portion 67 and the cover attachment portion 75 are provided by shifting the axes Lf and Lc. The frame attachment portion 67 is provided so that the axis center Af is located to offset from the straight line connecting the axis center Ac of the cover attachment portion 75 and the rotation axis center Ax on an imaginary plane perpendicular to the rotation axis center Ax of the motor unit 20. As a result, it is possible to suppress resonance.

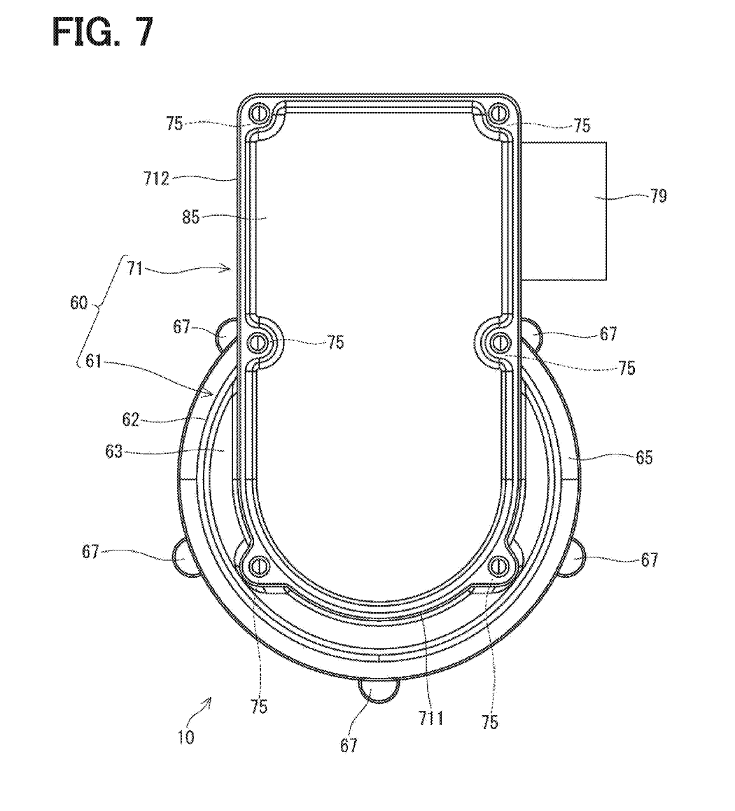

(Second Embodiment) A second embodiment is shown in FIG. 7. In this embodiment, the connector 79 is different from the above embodiment, so this is the main point of explanation. In this embodiment, the connector 79 is provided on the extended portion 712 to protrude in a side to the width direction. The opening of the connector 79 is provided to face outward (i.e., a right side on the paper of FIG. 7), and is provided to allow an insertion and removal operation of a wire harnesses etc. In other words, the insertion and removal direction of the connector 79 in this embodiment is perpendicular to the rotation axis center Ax.

In this embodiment, the connector 79 is provided to protrude outwardly from a projected area of the extended portion 712 in a direction of the motor axis. As a result, it is possible to insert and remove a wire harness from a side to an outer edge of the circuit housing portion 71. In addition, the same effects as those of the above embodiments are obtained.

(Other Embodiments) In the above embodiment, the connector has two openings and is located on a side to the output end of the extended area of the circuit housing portion or on a side of the circuit housing portion. In other embodiments, the connector may be provided at any location, such as protruding from a distal end of the circuit housing portion in the extended direction. The number of the openings is not limited to two, and may be one or three or more. The connector may also be divided into multiple portions, for example, including one opening facing a side direction and other one opening facing an axial direction.

In the above embodiment, the heat dissipating fins are provided annularly on an outside of the cylinder of the motor housing portion. The heat dissipating fins protrude outwardly in the radial direction from an outside surface of the motor housing portion. In other embodiments, the shape of the heat dissipating fins may be formed in a shape other than an annular shape, as long as the shape can promote heat dissipation of the motor drive device. In other embodiments, heat dissipation fins may be provided at locations other than the cylinder of the motor housing portion.

In the above embodiment, the circuit unit and the circuit housing portion are provided to protrude outward from the motor housing portion. In other embodiments, the shape of the circuit unit and the circuit housing portion may be different from the above embodiments, for example, they may be shaped to fit within the motor area. In the above embodiment, a length in a width direction of the circuit housing portion is smaller than a length in the width direction of the motor housing portion. In other embodiments, a length in the width direction of the circuit housing portion may be greater than or equal to a length in the width direction of the motor housing portion.

In the above embodiment, the motor drive device is applied to the main motor of the electric motorcycle. In other embodiments, the motor drive device may be applied to something other than the main motor. The motor drive device may also be applied to vehicles other than electric motorcycles or to devices other than in-vehicle equipment.

(Disclosure of Technical Concepts) This specification discloses a plurality of technical ideas described in the following enumerated items. Some of the items may be described in a multiple dependent form, in which a preceding item is alternatively referenced in subsequent items. Furthermore, some of the items may be described in a multiple dependent form that refers to another item in a multiple dependent form. These items described in multiple dependent form define a plurality of technical ideas.

(Technical Concept 1) A motor drive device, comprising: a motor unit (20) including a stator (22) around which a motor winding (21) is wound, a rotor (23) that rotates by energizing the motor winding, and a shaft (25) that rotates together with the rotor; a circuit unit (40) including a circuit board (41) on which electronic components (42) relating to energizing control of the motor winding are mounted; and a housing (60) including a motor housing portion (61) that accommodates the motor unit, a circuit housing portion (71) that accommodates the circuit unit, and heat dissipating fins (65) formed on an outer surface thereof, wherein the motor housing portion, the circuit housing portion, and the heat radiation fins are integrally molded.

(Technical Concept 2) The motor drive device according to Technical Concept 1, wherein the circuit housing portion is provided on a side of one end in the axial direction of the motor housing portion, that is formed in a cylindrical shape, and has a connecting portion (711) connected to the motor housing portion and an extended portion (712) extending outwardly from the connecting portion in a radial direction of the motor housing portion.

(Technical Concept 3) The motor drive device according to Technical Concept 2, wherein assuming that a direction in which the extended portion extends is an extended direction, and a direction perpendicular to the extended direction is a width direction, and wherein a length in a width direction of the circuit housing portion is smaller than a length in the width direction of the motor housing portion.

(Technical Concept 4) The motor drive device according to Technical Concept 2 or 3, further comprising: a connector (78) which is connectable to a battery (96) and is provided on the extended portion, wherein the connector is provided within a projected area of the extended portion in a direction of the motor axis.

(Technical Concept 5) The motor drive device according to Technical Concept 2 or 3, further comprising: a connector (79) which is connectable to a battery (96) and is provided on the extended portion, wherein the connector is provided to protrude outwardly from a projected area of the extended portion in a direction of the motor axis.

(Technical Concept 6) The motor drive device according to any one of Technical Concepts 2-5, further comprising: a frame member (81) attached to the frame attachment portion (67) provided on the motor housing portion and provided at an end of the housing on a side to the motor housing portion; and a cover (85) which is attached to a cover attachment portions (75) formed on the circuit housing portion and is located at an end on a side to the circuit housing portion of the housing, wherein the frame attachment portion and the cover attachment portion are provided to shift axes thereof.

(Technical Concept 7) The motor drive device according to any one of Technical Concepts 2-5, further comprising: a frame member (81) attached to the frame attachment portion (67) provided on the motor housing portion and provided at an end of the housing on a side to the motor housing portion; and a cover (85) which is attached to a cover attachment portions (75) formed on the circuit housing portion and is located at an end on a side to the circuit housing portion of the housing, wherein the frame attachment portion is provided so that an axis center thereof is located to offset from a straight line connecting the axis center of the cover attachment portion and the rotation axis center on an imaginary plane perpendicular to the rotation axis center of the motor unit.

The present disclosure is not limited to the above-described embodiments, and various modifications may be made within the scope of the present disclosure.

The present disclosure has been made in accordance with the embodiments. However, the present disclosure is not limited to such embodiments and configurations. The present disclosure also includes various modification examples and modifications within the scope of equivalents. In addition, various combinations and forms, and other combinations and forms which include only one element, more elements, or less elements are further included in the scope and the spirit of the present disclosure.

What is claimed is:

1. A motor drive device, comprising:
a motor unit including a stator around which a motor winding is wound, a rotor that rotates by energizing the motor winding, and a shaft that rotates together with the rotor;
a circuit unit including a circuit board on which electronic components relating to energizing control of the motor winding are mounted; and
a housing including a motor housing portion that accommodates the motor unit, a circuit housing portion that accommodates the circuit unit, and heat dissipation fins formed on an outer surface thereof, wherein
the motor housing portion, the circuit housing portion, and the heat dissipation fins are integrally molded.

2. The motor drive device according to claim 1, wherein
the circuit housing portion is provided on a side of one end in an axial direction of the motor housing portion, that is formed in a cylindrical shape, and has a connecting portion connected to the motor housing portion and an extended portion extending outwardly from the connecting portion in a radial direction of the motor housing portion.

3. The motor drive device according to claim 2, wherein
assuming that a direction in which the extended portion extends is an extended direction, and a direction perpendicular to the extended direction is a width direction, and wherein
a length in a width direction of the circuit housing portion is smaller than a length in a width direction of the motor housing portion.

4. The motor drive device according to claim 2, further comprising:
a connector which is connectable to a battery and is provided on the extended portion, wherein
the connector is provided within a projected area of the extended portion in a direction of a motor axis.

5. The motor drive device according to claim 2, further comprising:
a connector which is connectable to a battery and is provided on the extended portion, wherein
the connector is provided to protrude outwardly from a projected area of the extended portion in a direction of a motor axis.

6. The motor drive device according to claim 2, further comprising:
a frame member attached to a frame attachment portion provided on the motor housing portion and provided at an end of the housing on a side to the motor housing portion; and
a cover which is attached to a cover attachment portions formed on the circuit housing portion and is located at an end on a side to the circuit housing portion of the housing, wherein
the frame attachment portion and the cover attachment portion are provided to shift axes thereof.

7. The motor drive device according to claim 2, further comprising:
a frame member attached to a frame attachment portion provided on the motor housing portion and provided at an end of the housing on a side to the motor housing portion; and
a cover which is attached to a cover attachment portions formed on the circuit housing portion and is located at an end on a side to the circuit housing portion of the housing, wherein
the frame attachment portion is provided so that an axis center thereof is located to offset from a straight line connecting the axis center of the cover attachment portion and a rotation axis center on an imaginary plane perpendicular to the rotation axis center of the motor unit.
